(19) United States
(12) Patent Application Publication
(10) Pub. No.: US 2002/0035857 A1
(43) Pub. Date: Mar. 28, 2002

(54) Associate code system for use with unattended transfer devices

(76) Inventors: Mark Stein, Bethesda, MD (US); Steve Van Till, Ellicott City, MD (US); Redentor Casanova, Washington, DC (US)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 09/951,772

(22) Filed: Sep. 14, 2001

Related U.S. Application Data
(60) Provisional application No. 60/232,415, filed on Sep. 14, 2000.

(51) Int. Cl. E05B 47/00; E05B 47/06

(52) U.S. Cl. 70/277; 70/283

(57) ABSTRACT

A method for utilizing an associate network with a system for monitoring shipping may include the steps of identifying a list of associates; prescribing an access state for each of the associates; and authorizing access to the system to each of the associates in accordance with the associate's access state.

This application claims the benefit of the filing date of U.S. Provisional Patent Application No. 60/232,415, filed Sep. 14, 2000; which is incorporated herein by reference.

### BACKGROUND OF THE INVENTION

1. Field of the Invention

The invention relates generally to the field of unattended transfer devices. In particular, the present invention is directed to an associate code system for use with unattended transfer devices.

2. Description of Related Art

Consumers today are busier than ever, and are challenged to find a sustainable balance between work and family. As a result, consumers have shown a strong willingness to embrace innovations that bring convenience and flexibility to their lives. Two trends that illustrate this phenomenon are (a) telecommuting and other home-based work situations, and (b) convenience-driven self-service devices and utilities. It is estimated that there are over 10 million workers in the United States who telecommute (i.e., work from home rather than travel to their office to work) more than one day per week. That figure is in addition to the more than 24 million Americans who operate businesses from their homes. The dramatic rise in self-service innovations such as automatic teller machines (ATMs) and Internet-based commerce attests to how great the demand is for convenience and flexibility, especially when it is centered on the home.

One of the more unrewarding and time-consuming tasks for people who perform work at home or consumers who lead busy lives is the sending of outbound packages. These packages may be product returns for goods purchased through the Internet or via mail order catalogs, or work products developed at home and directed toward clients or co-workers. When individuals want to send packages from their residence, they generally must either commute to the Post Office (because the U.S. Postal Service will not accept packages weighing over one pound introduced into the mail stream at locations other than an actual Post Office) or offices of a shipping company e.g., Federal Express, United Parcel Service, etc.), or call to schedule a pick-up from the Postal Service or a delivery company.

### SUMMARY OF THE INVENTION

Therefore, a need has arisen for a device for the unattended transfer of goods.

In an embodiment, the invention is a method for utilizing an associate network with a system for monitoring shipping. The method may comprise the steps of identifying a list of associates; prescribing an access state for each of the associates; and authorizing access to the system to each of the associates in accordance with the associate's access state. The access state may set a number of system accesses allocated to each associate. Further, the system may provide at least one service, and the access state may identify the at least one system service, which each associate is authorized to access.

Other objects, features, and advantages will be apparent to persons of ordinary skill in the art in view of the following detailed description of preferred embodiments and the accompanying drawings.

### BRIEF DESCRIPTION OF THE DRAWINGS

For a more complete understanding of the present invention, the needs satisfied thereby, and the features and advantages thereof, reference now is made to the following descriptions taken in connection with the accompanying drawings in which:

FIG. 1 depicts a flush-mounted unattended transfer device according to one embodiment of the present invention;

FIG. 2 depicts an unattended transfer device with a one-way mechanism according to one embodiment of the present invention;

FIG. 3 depicts a secure door system according to one embodiment of the present invention;

FIG. 4 depicts secure door system having a full-size door according to one embodiment of the present invention;

FIGS. 5a-b depict a subterranean enclosure transfer system according to one embodiment of the present invention;

FIGS. 6a-b depict a tether transfer system according to one embodiment of the present invention;

FIG. 7a-c depict a peg board transfer system according to one embodiment of the present invention;

FIG. 8a-b depict a sensor transfer system according to one embodiment of the present invention; and

FIG. 9 depicts a multiple transfer bin device according to one embodiment of the present invention.

### DETAILED DESCRIPTION OF PREFERRED EMBODIMENTS

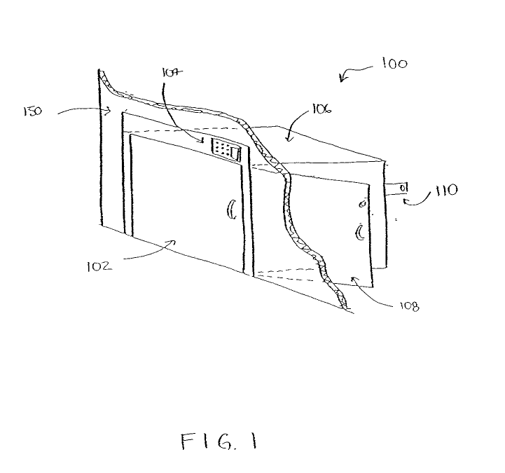

Preferred embodiments of the present invention and their advantages may be understood by referring to FIGS. 1-9, like numerals being used for like corresponding parts in the various drawings. Although the term “transfer” is used throughout this document, it should be recognized that, as used in this application, this term includes shipping, delivery and storage of goods.

The present invention is preferably used in conjunction with an unattended delivery or transfer device, such as the device described in U.S. Pat. No. 5,774,053 to Porter, entitled “Storage Device for the Delivery and Pickup of Goods,” which is incorporated herein by reference. The unattended transfer device preferably is equipped for communications, whether they be wireless or landline. In an embodiment, a wireless network may be used. In another embodiment, telephone lines may be used. In yet another embodiment, the radio spectrum may be used.

Other types of unattended transfer devices may also be used. For example, referring to FIG. 1, a flush-mounted unattended transfer device (e.g., a controlled access door) is provided. Device 100 may be mounted in exterior wall 150 of a building, such as a house, a garage, an office building, etc. Device 100 includes an access portal, such as exterior door 102, access controller 104, interior compartment 106, and interior door 108. Interior compartment 106 may be a solid-walled compartment, as shown in FIG. 1, or it may be a cage.

Access controller 104 controls the access to interior compartment 106 by unlocking or locking exterior door 102. Access controller 104 may include an input device, such as a keypad, that allows a person to enter a code into the device. A variety of input devices may function as access controller 104, including, but not limited to, an infrared receiver, a radio antenna, an optical scanner, a magnetic strip reader, a lock and tumbler, and combinations thereof.

Device 100 also may include locking mechanism 110 to prevent interior door 108 from being opened from the inside of interior compartment 106. Locking mechanism 110 may be a lock and tumbler device or a similar lock; in other embodiments, locking mechanism 110 may comprise a latch on the outside of interior door 108.

Device 100 may operate in a manner similar to the device disclosed in U.S. Pat. No. 5,774,053. Generally, during a delivery, access to interior compartment 106 may be granted by access controller 104, and an item for delivery may be placed within interior compartment 106. Exterior door 102 then is closed. For a shipment, the user may place an item in interior compartment 106 via either exterior door 102 or interior door 108.

Access controller 104 then transmits information to a remote location. This information may include, inter alia the access time, the access code, the number of packages, etc. The information may also include a status of the device, such as door status ( e.g., open or closed, battery status, communication signal strength, etc.)

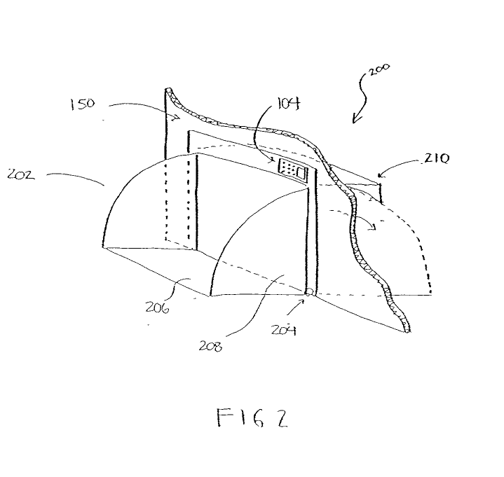

Referring to FIG. 2, an unattended transfer device with a one-way mechanism according to one embodiment of the present invention is provided. Device 200 includes access controller 104, which is substantially identical to that of flush mounted transfer device 100. One-way mechanism 200 also includes rotating door 202 that is mounted on hinge 204. As shown in the figure, rotating door 202 includes walls 206 and 208, which are mounted at a suitable angle to each other. In an embodiment, walls 206 and 208 may be substantially perpendicular to each other; other appropriate angles may be used.

Rotating door 202 may include at least one handle (not shown) for allowing the user to rotate rotating door 202 open or closed.

During a delivery, when rotating door 202 is unlocked, the user may extend rotating door 202 outward to accept item 210. Item 210 may be placed on wall 206 of rotating door 202, and rotate rotating door 202 closed. Once rotating door 202 is closed, item 210 shifts to rest on wall 208 of rotating door 202. For shipping, the user is on the inside, the user may place item 210 on wall 208 of rotating door 202. If the user is on the outside, the process is the same as a delivery.

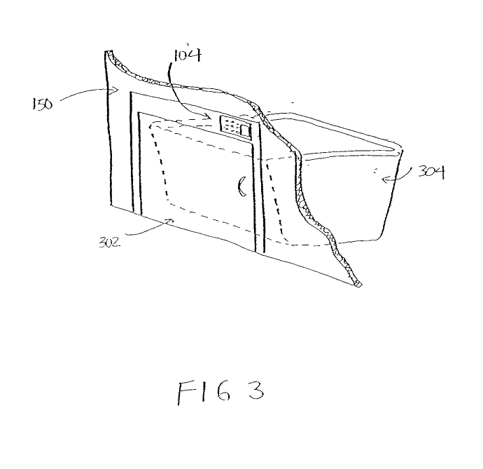

Referring to FIG. 3, secure door transfer system 300 according to an embodiment of the present invention is disclosed. In this embodiment, the user may decide to permit access to a limited area a building (e.g., a garage, a breezeway, a mud room, or the like) and protect the rest of the building through a separate security system. When access is granted by access controller 104, exterior door 302 is unlocked, providing access to the interior of a portion of the building. In an embodiment, external door 302 may open to reveal a tote or a basket (not shown), or simply an open area on the floor, onto which any deliveries may be placed.

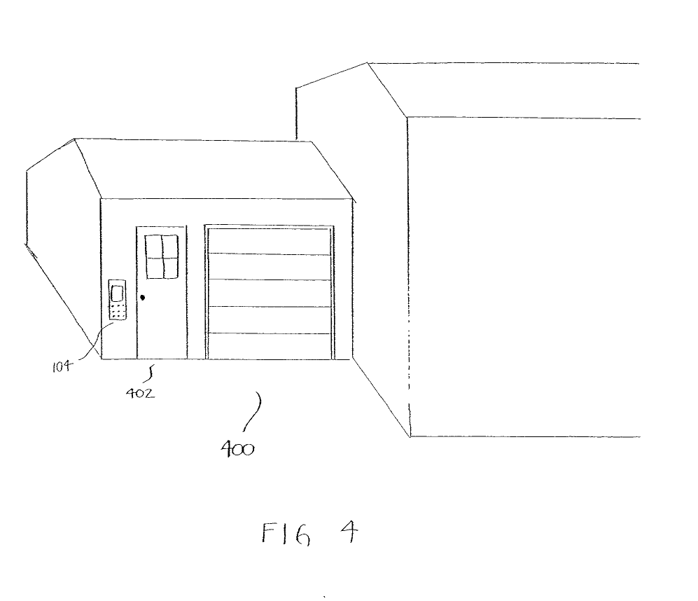

Referring to FIG. 4, in another embodiment, external door 402 of secure door system 400 may be a full size door, permitting an authorized person to enter an area of a building ( e.g., a garage or a separate building) to make a delivery or a pickup. If necessary, security to the remainder of the building may be achieved by an additional security system, including locking a door to the building, or providing an electronic (e.g., motion detectors) or video surveillance system to prevent or announce entry into unauthorized areas.

In an embodiment, external door 402 may be an interior door of a building. For example, external door 402 may open to reveal a storage area, such as a room, a basement, and the like. Thus, the present invention may be used in both personal and commercial storage areas. In yet another embodiment, external door 402 may be used as a replacement for any conventional door.

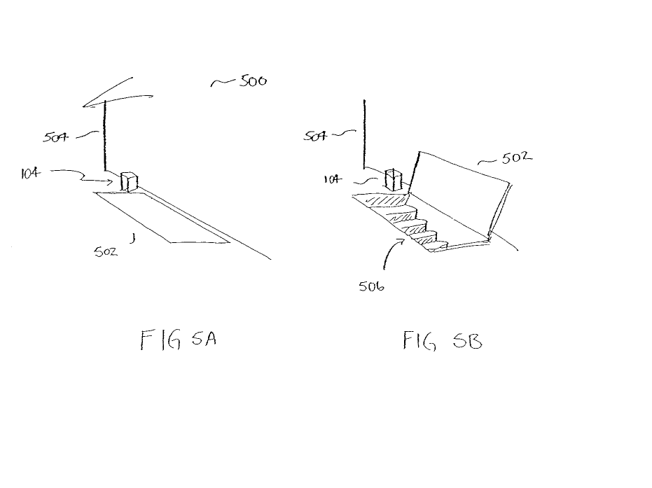

In another embodiment, a subterranean enclosure transfer system is disclosed. For example, referring to FIGS. 5a and 5b, a user may use access controller 104 to unlock access door 502 that is adjacent to building 504, which leads to enclosed underground area 506, such as the entrance to a storm cellar. The user gains access to area 504 through external door, 502, or through an internal door (not shown) similar to those described above. This embodiment may be less obtrusive from an aesthetic standpoint, but may also benefit from temperature control advantages provided by subterranean thermodynamics ( e.g., substantially constant year-around temperatures of about 55° F.).

Alternatively, a “safe zone” may be provided into which packages may be inserted and from which they cannot be removed without triggering an alarm. The safe zone for unattended transfer may be a section of a property, including a porch, a deck, a carport, or other designated area that may be adjacent to or near a building or home. Security may be provided through some non-enclosed means of attachment or sensing, as will be discussed below.

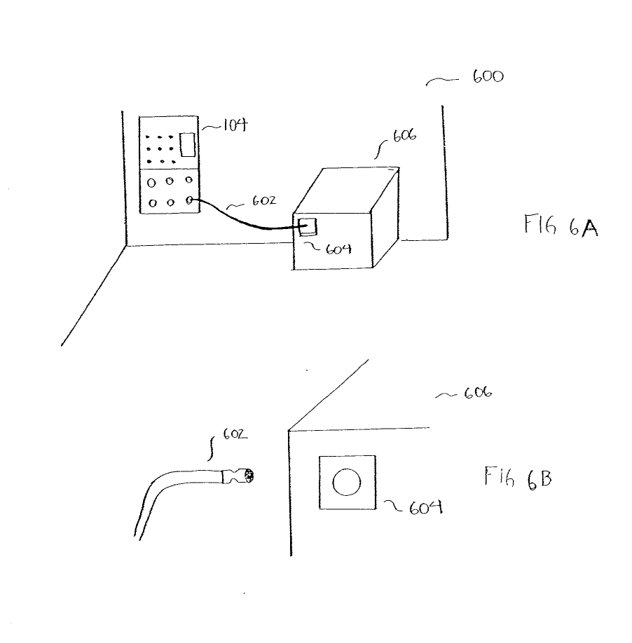

In another embodiment, a tether transfer system may be provided. Referring to FIGS. 6a and 6b, tether system 600 may use a small lanyard or plug-in that is attached to the shipping package or container. Upon delivery of a package to the home, tether 602 may be received in connection 604 that is provided in container 606. Container 606 is then protected from theft until tether 602 is released by access controller 104 by a entering a code or providing a key. In an embodiment, tether 604 may be secured to container 606 in such a way that container 606 or its contents may be damaged or destroyed in order to remove container 606 without properly unlocking tether 602. Alternatively, tether 602 may be integral to the locking system on the home, and container 606 may come with either a loop (not shown) through which tether 602 may pass, or female connector 608 to match male end 610 of tether 602.

In another embodiment, a tether may be integral with the container, and may be received by a receptacle provided in the secure area. In yet another embodiment, a special container may be provided. The special container may be made of a material, such as plastic, to provide durability, and may be equipped with either a tether or a receptacle for the tether. The special container may be provided with a locking mechanism as well.

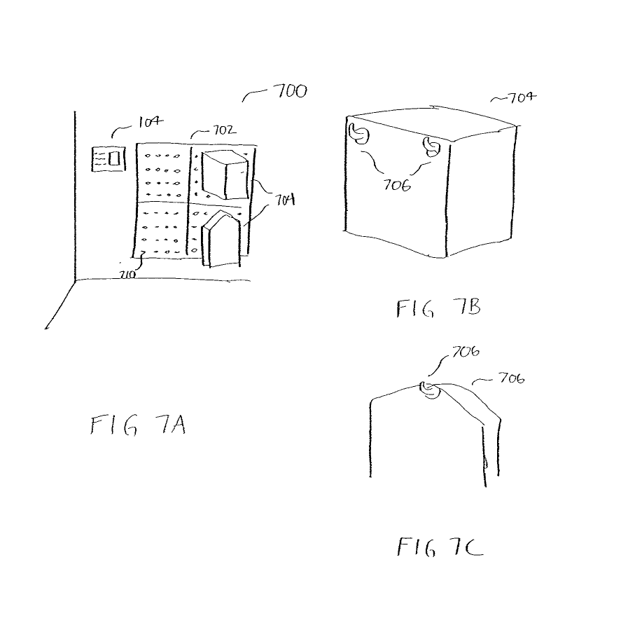

In another embodiment, a peg board transfer system may be provided. A peg board system includes one or more hooks attached to a package. In FIG. 7a, pegboard system 700 includes access controller 104 and pegboard 702, which may be divided into a plurality of zones, or regions. Packages 704, such as those shown in FIGS. 7b-c, may be delivered with pegs 706 protruding from a portion of the package. Packages 704 may include special containers that have pegs 706 formed integrally therewith, or pegs 706 may simply be attached to packages 704.

Similar to the tether design, pegs 706 are received by holes 710 in pegboard 702. Pegboard 702 may be part of a larger, home or business security system where any inserted pegs may then be secured in place by a locking mechanism. Packages 704 are then secure until they are released by access controller 104 through the actions of someone possessing a key (or codes that serve as a key). Pegs 706 may be secured to package 704 in such a way that package 704 or its contents may be damaged or destroyed in order to remove it without unlocking peg board 702.

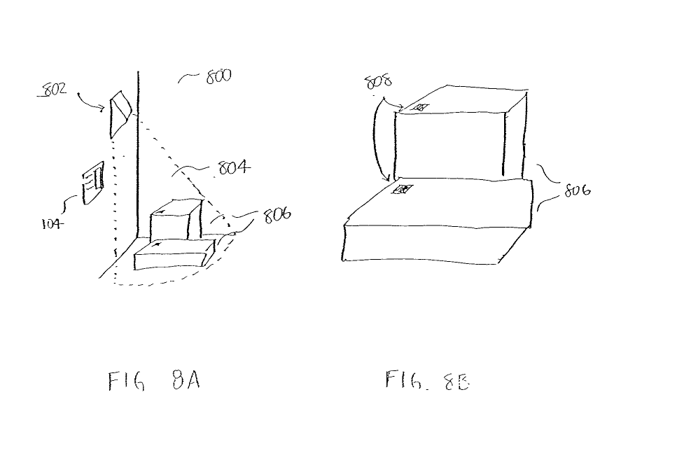

In yet another embodiment, a sensor transfer system is provided. Referring to FIGS. 8a and 8b, sensor system 800 may operate by using electric sensor 802 that emits electric beam 804 in a predetermined area. Packages 806 include sensors 808 that may be located on the outside of package 806, or within package 806. Sensor 808 may be a small chip similar to the shoplifting prevention device attached to clothing in some retail stores, such as U.S. Pat. No. 4,123,749 and U.S. Pat. No. 5,874,896. In yet another embodiment, a sensor 808 may be integrated with a special container (not shown).

Once package 806 including sensor 808 is recognized, sensor system 800 is switched into “locked” mode and maintains electronic contact with the package 806. If this contact is interrupted, a warning is provided. This may include sounding an alarm, on activating other security measures (e.g., activating an electronic camera to capture activity in the area). As with other embodiments, to remove package 806 from the area, an authorized recipient may be required to possess a key or a code to disable the alarm.

Regardless of the specific embodiment, the unattended transfer device may be part of a simple physical security mechanism, or part of a broader device with intelligence. For example, the intelligence may be used to notify the homeowner of delivery of the package. For deliveries to the system, input codes that identify the package may be used, so that notification could be specific as to the package, the Shipping Company, the time of delivery, and the like

Further, the user may be required to register the unattended transfer device with a service provided. This may include transmitting the individual's name, social security information, home and work address, telephone and other digital/analog communication numbers or electronic mail addresses, as well as information regarding the individual's preferences as a user of the system, including preferred means of notification, preferred shipping provider, preferred transfer device pick-up times, a “buddy-list” of additional people authorized to use the device, and so forth. The user also may register payment information into the central database. A preferred method of payment is a credit card; however, it is possible that payment may be accepted via a debit card, check, electronic-check (“e-check”), or electronic-wallet (“e-wallet”)—the latter two examples referencing forms of electronic payment made over the Internet.

In an embodiment of the present invention, a third party may serve as an intermediary between the user, which may be a consumer or business person, and the shipping company. The third party may be referred to as a Network Agent.

In another embodiment, a plurality of unattended transfer devices may be colocated in a “post office box” type of arrangement. In this embodiment, the individual “bins” may each by owned, or they may be commonly owned by a party, and “leased” or rented to users. For example, a user may rent an individual bin in the same manner that a person may rent an apartment, and may have exclusive possession of that individual bin during that time period. A group of users may rent an individual bin in the same manner. Further, a user may rent an individual bin for a single delivery.

An important issue associated with shared resources is their effective utilization. Utilization of a cluster box may be described in classic telecom theory. For example, arrival rates (both inbound and outbound), how often the bin is being used and by how many users; and average handle times (how long the package is in the bin from insertion to pickup) should be considered.

Package size is an important consideration with such a device. For smaller packages, a common bin may be provided, such that access to remove packages may be limited to the carrier. These would be very similar to the bins that carriers use today to drop off packages for pickup. For larger packages, a common cluster of bins may be used. As will be described below, a combination of large and small bins may be provided in a common device.

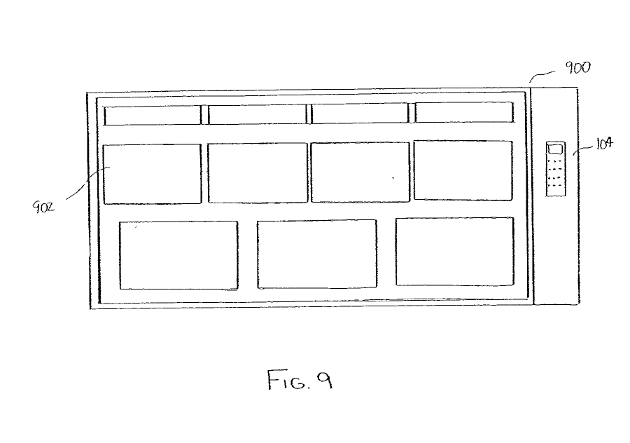

Referring to FIG. 9, an example of a multiple transfer bin device 900 is provided. In this figure, a plurality of bins 902 are provided in device 900. In one embodiment, bins 902 may be the same size. In another embodiment, bins 902 may be of different sizes. For example, bins 902 may be provided different sizes that accommodate shipping envelopes (e.g., FedEx® letters, UPS® PadPacks®, and the like), small or medium packages, and large packages. If bins 902 are provided on a per-delivery basis, a delivery to a larger bin may cost more than a delivery to a envelope bin.

In another embodiment, some of bins 902 may be provided with additional convenience features, such as having a heater or a refrigeration unit. In one embodiment, a common heater or a common refrigeration unit, or both, may be provided for device 900, and may be individually (or selectively) activated by the person leaving the item in the particular bin. If bins 902 are not owned by a user, an additional charge may be imposed for use of such features.

Bins 902 may be provided with an indicator that indicates when the bin is in use. In an embodiment, each bin 902 may be provided with a LED that illuminates when the bin is in use. In another embodiment, a central display (not shown) may indicate when a bin is in use.

Device 900 may be provided with at least one access controller 104. Access controller 104 may be substantially the same type as described in conjunction with other embodiments. Other devices, however, are within the contemplation of the present invention.

In an embodiment, a separate access controller 104 is provided for each bin 902. All access controllers 104 may be linked to a common processor, or they may be completely independent. In an embodiment, access controllers 104 share a common communication port.

Owners of unattended transfer devices, such as those as described above, may choose to grant other individuals or other parties code creation privileges and temporary access to their unattended transfer devices. As used herein, the terms “associate” and “associates” include individuals, parties, and businesses, while the term “sponsor” refers to an owner, lessee, or other individual or party that is a member of an unattended transfer device Network.

The associate may be given direct access (i.e., the associate interacting with the unattended transfer device and making a delivery) or indirectly (the associate providing a delivery agent, such as a shipping company, an item to deliver to the unattended transfer device).

As discussed above, the sponsor and the associate may both be individuals. Examples of transactions between such include, inter alia, friends exchanging tools, relatives sending unanticipated gifts, and a friend using an sponsor's unattended transfer device to receive items purchased on line.

In order for an individual become an associate, the individual may be required to participate in a setup phase. In general, this happens before the individual becomes an associate and enters the usage phase.

There are three steps in the setup phase. The first step is the invitation. The purpose of the invitation step is to let the sponsor add or start an associate list. The associate list may contain a list of individuals, parties, businesses, etc. that the sponsor will interact with as associates. Sponsors may plan to interact with their associates only one time, sparingly, or on a regular basis. Once an associate is added to the associate list, any member of this list of associates may be allowed a series of one-time (albeit repeated) accesses to certain Network Services on behalf of the sponsor (i.e., they may create and use perishable access codes).

In an embodiment, the sponsor may have the ability to invite an individual or party to be an associate. This may be accomplished via e-mail.

In an embodiment, the sponsor may initiate the e-mail from the Network's website on the Internet. The sponsor may be presented with a form, and requested to enter information about the potential associate, including an e-mail address, a challenge for the potential associate, and other information as required. In one embodiment, the challenge may be a question, the answer to which is a shared secret known by the owner and the proposed associate. In another embodiment, the challenge may be a digital certificate. Other challenges that assist in identifying the potential associate may be used.

The sponsor may also be presented with a list of Network privileges and services that the potential associate may use. For example, the owner may decide to allow the potential associate to create two-way codes (e.g., for drop off and pick-up of drycleaning). Once the sponsor identifies the privileges and services, the owner submits the form to the Network.

After the form is submitted, the Network may send an e-mail to the e-mail address entered by the sponsor. This e-mail may include information including, inter alia, the Owner's name, the date, an overview of the associate network, instructions for enrollment, a candidate code, and an acceptance link that links the potential associate to an enrollment page on the Internet.

The sponsor may be notified of the status of any invitations they have issued.

If the potential associate decides follow the “accept” link, the potential associate may be linked to the enrollment page, and presented with a form that may be pre-populated with data associated with both the sponsor and the potential associate. The potential associate may be required to enter additional information.

The potential associate may also be presented with a user agreement. The user agreement states the terms of use, liabilities and responsibilities of an associate. The potential associate may be required to accept the terms and conditions of the user agreement before being allowed to become an associate.

The potential associate may be given the opportunity to choose a username and password to log into the Network. In an embodiment, the potential associate may be prompted to select a unique username and password, and prompted to select a different username should the username be already taken. The username and password selection process is known in the art.

In another embodiment, the potential associate may be assigned a username by the Network.

In an embodiment, the potential associate may be assigned a temporary password, and will be requested to change that temporary password when the potential associate logs in to the Network for the first time.

The potential associate may be notified by e-mail that the application has been submitted. The e-mail may contain a confirmation of the registration information submitted.

Upon completion of this process, the potential associate has created an account; this account, however, remains inactive until the potential associate is validated by the sponsor.

When the sponsor logs onto the Network, the sponsor may be notified that an application for a potential associate was received. The sponsor may also receive an e-mail notification as well. The sponsor may then validate the potential associate by reviewing the potential associate's answer to the challenge.

In one embodiment, the correctness of the answer to the challenge may be solely at the sponsor's discretion. In other words, the sponsor may validate a potential associate regardless of the answer that the potential associate provides to the challenge. In another embodiment, digital certificates may be exchanged to validate the potential associate.

Once the potential associate is validated, the potential associate becomes an associate, and may be notified, via e-mail, of this. The e-mail may contain registration information as entered by the potential associate.

If the sponsor chooses to not validate the potential associate, the potential associate's account is not created. As discussed above, it is possible that the potential associate could provide the proper answer to the challenge, and the sponsor could decide not to validate the potential associate. Even though the potential associate is not selected, the potential associate could be invited again in the future.

The sponsor may have the option of terminating a relationship with an associate. In one embodiment, the associates may be removed from the associate list, temporarily or permanently. Terminated associates may be re-invited to be on an associate list. In one embodiment, a terminated associate must go through the entire process again (invitation, enrollment, and validation). In another embodiment, validation is only required to reactivate a terminated associate. The associate account information may be maintained for the terminated associate; in another embodiment, a new account is created for a re-invited associate.

In one embodiment, the sponsor, associate, and other Network members may be permitted to create aliases for usernames. For example, the associate's username may be “EL337HAX0R”, but the sponsor, associate, or Network member may choose to alias this username with “Beth.” Further, a Network member, such as a merchant, may choose to identify owners and associates with account numbers.

Once an associate is validated, the associate may begin using the privileges and services authorized by the owner. In general, the associate may use these services from the Network's website on the Internet.

Associate usage may be classified into two categories: unattended transfer device usage, and Network website usage. Unattended transfer device usage is when the associate may access the sponsor's unattended transfer device for pickup or delivery, while Network website usage involves granting the associate to access the Network's website to check on the status of the sponsor's unattended transfer device. Associates may create Associate Access Codes (AACs) via the Network or a simplified browser-based application. In one embodiment, the associate may only be given permission to view items relevant to that associate (e.g., codes that that associate created.) In any case, the sponsor may be notified of their associate's actions.

The associate may be allowed to access the unattended transfer device by using the AAC created for or by the associate. In essence, the associate may create an AAC to drop off or pick-up an item.

Examples of the interaction between the sponsor and the associate are provided. It should be noted that these examples are provided for exemplary purposes only, and do not limit the present invention in any way.

As an example of a scenario in which a sponsor would leave something for the associate to retrieve from the unattended transfer device, the following is provided. The sponsor may deposit item(s) into the unattended transfer device. The sponsor then notifies the associate about the item(s) and creates an AAC for the associate. The sponsor may include a description of the item(s), and may associate the AAC with the particular associate. The associate may access the unattended transfer device and retrieve the item(s) using the given AAC.

An example of the associate dropping off an item for a sponsor in the sponsor's unattended transfer device is provided. The associate logs in to the Network and creates an AAC. When created, the AAC is associated with the particular associate, and the associate may enter a description for the item(s) to be placed in the unattended transfer device. The associate accesses the unattended transfer device and drops off the item using the AAC. The sponsor may then retrieve the item(s).

An example of a “round trip,” starting with the sponsor, is provided. The sponsor deposits item(s) into the unattended transfer device for the sponsor's associate. The sponsor then notifies the associate about the item(s) and creates an AAC for the associate. The sponsor may include a description for the item(s) and may associate the AAC to a particular associate. The associate accesses the unattended transfer device and picks up the item using the given AAC. Later, the associate returns and drops off the item(s) using the same AAC.

There may be restrictions on the use of round trip AACs. For instance, round trip AACs may be prevented from being renewed. Round trip AACs may have a limited existence in which they may be used. Sponsors may have the ability to restrict their associates from creating round trip AACs.

As discussed above, the associate may be permitted to log into the Network. In one embodiment, the associate may log in directly, or indirectly (e.g., by using a shipping company or a “pop-up” web-based application).

For example, the associate may select which sponsor's unattended transfer device the associate wants to arrange a delivery to (if the associate has more than one sponsor). The associate may arrange a delivery, and may view a status of deliveries,.

In an embodiment of the present invention, the Associate may create access codes (AACs) Each AAC is associated with a particular associate. The associate information relating to the AAC is explicitly recorded.

In order to create an AAC, the associate enters a description of the item or event associated with the AAC, and may enter information, such as a specific time frame in which the AAC is valid, a tracking number (if applicable), and the number of times the AAC may be used. In one embodiment, the AAC may have a maximum use of two (for round trips). In another embodiment, the associate does not have the ability to renew AACs once they are used.

If the associate chooses, an address label for the associate to printout and attach to the item being delivered may be created. In one embodiment, the label may have the sponsor's address with the AAC printed on address line two. If the associate desires to use a pre-printed form from a shipping company (e.g., Federal Express, United Parcel Service, and the like), the address label will not be used.

The sponsor may be notified of any codes created by the sponsor's associate(s) via email, or when the sponsor accesses the Network. This notification may include, inter alia, the associate's name, the associate's e-mail address, the time created, an item description, an identification of the shipping company (or “self” if the associate is doing the drop-off him/herself), a tracking number (if applicable), and the like.

The sponsor and the associate may be notified when the associate code is sued. The notification may be the standard notification, with the addition of the creator of the code included in the e-mail. The event may be described as a pick-up, drop-off, or a leg of a round trip.

When the sponsor accesses the Network web page, the sponsor may have access to an associate administration page. This page allows the sponsor to invite associates, validate associates, terminate associates, schedule time-based permission to access the unattended transfer device, and the like.

The sponsor may be able to monitor the sponsor's associate(s) by an associate activity page. This may provide the sponsor the ability to review a log of each associate(s) activities.

According to another embodiment of the present invention, the owner and the associate may be businesses, providing a “B2B” exchange. Example of such an exchange include a supplier sending replacement parts to a retailer, a head office sending items to field sales office. Further, in another embodiment, the owner may be an individual and the associate may be a business, providing a “B2C” exchange. Examples of such exchanges include a dry cleaner creating a code to drop-off clothing to an owner. This may have particular application when a local merchant, replenishment agents, service providers, and the like, need to deliver unanticipated items to the owner's unattended transfer device. Having such parties as associates facilitates this end.

Such codes may be generated by the merchant automatically. For example, an owner joins a wine-of-the-month club, and receives a bottle of wine every month. The merchant, as an associate, may automatically create an access code to deliver the wine to the owner's unattended transfer device.

In another embodiment, a corporation may purchase unattended transfer devices for its employees. An example of such is a corporate customer that will use a group of unattended transfer devices as part of its business process, such as an insurance company delivering new product descriptions to all of their sales force in a given area, each member of the sales force owning or having access to an unattended transfer device.

Participating B2B or B2C merchants may be pre-qualified as “trustworthy” by Network and will be presented to users as “pre-authorized” users that they may wish to select for various services, and thereby grant code creation capabilities.

These pre-qualified business partners will be different than businesses unknown to Network (or having no relationship with Network), which the owner may simply treat as an associate as discussed above.

Thus, in an embodiment, the invitation/enrollment/validation process described above may be circumvented in the case of participating B2B or B2C merchants needing to create codes on unattended transfer devices. In another embodiment, the qualification and authorization process may be handled offline, and the merchants will have identities and service descriptions created by Network.

In another embodiment, the owner may be a business, or a corporation, that has access to multiple unattended transfer devices.

A owner may be presented with a list of participating merchants when the owner accesses the associate permission page. This list may be presented by market data, such as geographic location, preferences, and the like. The merchants may already qualify as associates for the owner. The owner may choose to activate these merchants as associates.

The Network may have the ability to administer groups of merchants. This may include creating groups, editing groups, and removing groups.

Corporate owners may be able to view activities by groups, including creating AACs by group.

The B2B Network Customer may have the ability to download or print a CSV file, or formatted HTML page listing all of the AACs created by group. This will lend itself to label printing and mailing.

The B2B Network Customer may have the ability will have the ability to create labels, including the mailing address, and the AAC on the second address line.

In another embodiment, the all owners of unattended transfer devices may be associated with multiple service providers. This will give the Network the ability to administer limited functionality on the unattended transfer devices. Examples of such services include welcome packages, battery replacement programs, and permission marketing of physical goods, upgrades and replacements for field service.

The Network will be able to create “Associate Service”. Owners will be able to “sign up” for as a one-time associate service or “subscribe” to a periodic associate service. Associate services may be include creating AACs, receiving batteries in a battery replacement program, receiving a welcome package.

The Network Services may have the ability to create groups to present associate services to, cancel associate services, extend associate services, and the like. Owners may be able to administer their own associate services, including signing up for an associate service, subscribing to a periodic associate service, unsubscribing to associate services, and canceling an instance of an associate service.

While the invention has been described in connection with preferred embodiments and examples, it will be understood by those skilled in the art that other variations and modifications of the preferred embodiments described above may be made without departing from the scope of the invention. Other embodiments will be apparent to those skilled in the art from a consideration of the specification or practice of the invention disclosed herein. It is intended that the specification is considered as exemplary only, with the true scope and spirit of the invention being indicated by the following claims.

What is claimed is:

1. A method for utilizing an associate network with a system for monitoring shipping, comprises the steps of:
identifying a list of associates;
prescribing an access state for each of the associates; and
authorizing access to the system to each of the associates in accordance with the associate's access state.

2. The method of claim 1, wherein the associates are selected from the group consisting of individuals, organizations and businesses.

3. The method of claim 1, wherein the access state sets a number of system accesses allocated to each associate.

4. The method of claim 1, wherein the system provides at least one service and the access state identifies the at least one system service, which each associate is authorized to access.

5. The method of claim 1, wherein the system comprises at least one unattended transfer device.

6. The method of claim 1, wherein a perishable access code issues to each associate accessing the system.

7. The method of claim 1, further comprising the step of informing each of the listed associates of the identity of the other associates.
